(19) United States
(12) Patent Application Publication
(10) Pub. No.: US 2012/0066166 A1
(43) Pub. Date: Mar. 15, 2012

(54) Predictive Analytics for Semi-Structured Case Oriented Processes

(75) Inventors: Francisco Phelan Curbera, Hawthorne, NY (US); Songyun Duan, Hawthorne, NY (US); Paul Keyser, Hawthorne, NY (US); Rania Khalaf, Hawthorne, NY (US); Geetika T. Lakshmanan, Hawthorne, NY (US)

(73) Assignee: International Business Machines Corporation, Armonk, NY (US)

(21) Appl. No.: 12/879,747

(22) Filed: Sep. 10, 2010

(51) Int. Cl. G06N 7/02

(52) U.S. Cl. 706/52

(57) ABSTRACT

A method for predictive analytics for a process includes receiving at least one trace of the process, building a probabilistic graph modeling the at least one trace, determining content at each node of the probabilistic graph, wherein a node represents an activity of the process and at least one node is a decision node, modeling each decision node as a respective decision tree, and predicting, for an execution of the process, a path in the probabilistic graph from any decision node to a prediction target node of a plurality of prediction target nodes given the content.

### BACKGROUND OF THE INVENTION

1. Technical Field

The present disclosure generally relates to predictive analytics for case-oriented semi-structured processes.

2. Discussion of Related Art

Semi-structured processes are emerging at a rapid pace in industries such as government, insurance, banking and healthcare. These business or scientific processes depart from the traditional structured and sequential predefined processes. The lifecycle of semi-structured processes is not fully driven by a formal process model. While an informal description of the process may be available in the form of a process graph, flow chart or an abstract state diagram, the execution of a semi-structured process is not completely controlled by a central entity, such as a workflow engine. Case oriented processes are an example of semi-structured business processes. Newly emerging markets as well as increased access to electronic case files have helped to drive market interest in commercially available content management solutions to manage case oriented processes.

Traditional business process management system (BPMS) products do not support case handling well and lack the requisite capabilities to coordinate this more complex use case. Business process management systems typically include restrictions such as rigid control flow and context tunneling. Context tunneling refers to the phenomena in workflow management systems where only data needed to execute a particular activity is visible to respective actors but not other workflow data. These restrictions allow BPMS to make processes transparent and reproducible and provide the means for intricate mining of activities and process related information. Case handling systems aim for greater flexibility by avoiding such restrictions. Case handling systems typically present all data about a case at any time to a user who has relevant access privileges to that data. Furthermore, case management workflows are non-deterministic, meaning that they have one or more points where different continuations are possible. They are driven more by human decision making and content status than by other factors.

According to an embodiment of the present disclosure, a need exists for predictive analytics for case-oriented semi-structured processes.

### BRIEF SUMMARY

According to an embodiment of the present disclosure, predictive analytics for a process includes receiving at least one trace of the process, building a probabilistic graph modeling the at least one trace, determining content at each node of the probabilistic graph, wherein a node represents an activity of the process and at least one node is a decision node, modeling each decision node as a respective decision tree, and predicting, for an execution of the process, a path in the probabilistic graph from any decision node to a prediction target node of a plurality of prediction target nodes given the content.

According to an embodiment of the present disclosure, predictive analytics for a process includes receiving a probabilistic graph modeling the at least one trace of the process, wherein a node of the probabilistic graph represents an activity of the process and at least one node is a decision node, determining content at each node of the probabilistic graph, modeling each decision node as a respective decision tree, and predicting, for an execution of the process, whether two nodes of the probabilistic graph coincide given the content, wherein the content is used to determine correlation coefficients between the two nodes.

### BRIEF DESCRIPTION OF THE SEVERAL VIEWS OF THE DRAWINGS

Preferred embodiments of the present disclosure will be described below in more detail, with reference to the accompanying drawings:

FIG. 1 shows an exemplary pairwise Pearson correlation according to an embodiment of the present disclosure;

FIG. 2 is a flow chart of a method for an end-to-end prediction according to an embodiment of the present disclosure;

FIG. 3 is a probabilistic graph of an automobile insurance claims scenario according to an embodiment of the present disclosure;

FIG. 4 is a binary decision tree learned to predict whether sendRepairRequest would execute given the document contents accessible at carShouldBeTotaled according to an embodiment of the present disclosure;

FIG. 5 is a binary decision tree learned to predict whether sendRepairRequest would execute given the document contents accessible at retrieveAccidentReport according to an embodiment of the present disclosure;

FIG. 6 is a binary decision tree learned to predict whether sendRepairRequest would execute given the document contents accessible at carShouldBeTotaled according to an embodiment of the present disclosure; and

FIG. 7 is a diagram of a computer system for implementing an end-to-end prediction according to an embodiment of the present disclosure.

### DETAILED DESCRIPTION

Given the document-driven nature of case executions, the present disclosure describes methods for providing business users with some insight into how the contents of the documents (e.g., case files containing customer order details) they currently have access to in a case management system affect the outcome (e.g., future activities) of the activity they are currently involved in. According to an embodiment of the present disclosure, predictions are determined for case-oriented semi-structured processes. Case history is leveraged to understand the likelihood of different outcomes at specific points in a cases execution, and how the contents of documents influence the decisions made at these points. Probabilistic and learning techniques are applied to develop methods for conducting analytics on case history data.

The processes described herein are not required to be structured and may be informal. In particular the processes have not been modeled in terms of a formal process model (e.g., wherein all flows in the process are known and guaranteed). It should be understood that methods described herein are also applicable in cases where a formal process model breaks down, e.g., when a process deviates in an unexpected way from the formal process modal. Methods described herein are applicable to acyclic business processes with no parallelism.

According to an embodiment of the present disclosure, it may be assumed that a provenance-based system collects case history from diverse sources and provides integrated, correlated case instance traces where each trace represents an end-to-end execution of a single case including contents of documents accessed or modified or written by each activity in the trace. The correlated case instance execution traces are used as input of predictive analytics for case-oriented semi-structured processes. It should be understood that methods described herein are applicable to partial traces in cases where end-to-end execution data is not available. For example, in a currently executing business process, the outcome of the business process can be predicted based on the contents of documents currently available and known thus far, as well as traces of previous execution instances of the business process. In particular underlying methods, such as decision trees and Markov chain rule, do not require all data variables to be initialized in order to make a prediction for the business process instance that is currently executing.

Provenance includes the capture and management of the lineage of business artifacts to discover functional, organizational, data and resource aspects of a business. Provenance technology includes the automatic discovery of what actually has happened during a process execution by collecting, correlating and analyzing operational data. The provenance technology includes the identification of data collection points that generate data salient to operational aspect of the process. This requires understanding a process context. Information and documentation about operations, process execution platforms, and models help determine the relevant probing points. A generic data model that supports different aspects of business needs to be in place to in order to utilize the operational data. The collected data is correlated and put into the context in order to have an integrated view.

According to an embodiment of the present disclosure, predictive analytics for case-oriented semi-structured processes includes the construction of an Ant-Colony Optimization (ACO) based probabilistic graph and the determination of a content and activity correlation for prediction.

Referring to the ACO-based probabilistic graph, since the lifecycle of semi-structured processes is not fully driven by a formal process model, a probabilistic graph is mined from case execution data rather than settling on mining a formal process model. By applying ACO techniques a probabilistic graph is constructed from traces that represent correlated case history data.

Referring to the determination a content and activity correlation for prediction, by applying a decision tree learning method, a correlation between the content of documents accessed by an activity and the execution of one of its subsequent (or downstream) activities in a semi-structured case oriented process is determined. For example, one can predict correlation between activities A and B, where A is an ancestor of B in all trace executions, based on document contents accessed by A, where B is connected to A by a single edge, B is connected to A by two or more edges or B is one of the final outcomes of the process or graph. Furthermore, correlation coefficients can be used to predict if two activities, or two different groups of activities, where each group has between 1 or k members, coincide.

It should be understood that document content and the values thereof are not limited to numeric type data and may include any data type having a value affecting a likelihood of an outcome of an activity, including non-numeric type data. For example, for non-numeric document content, the content may be modeled as data values in a document. More generally, the document content includes a variable or state that impacts a likelihood of an outcome. Furthermore, the content or data variables in one or more documents impact whether or not a particular outcome in a process will occur and also highlight under what circumstances the outcome will occur. Here, the circumstances are the values of those data variables that will lead to a given outcome. For example if x<5 and y>10, then outcome A occurs.

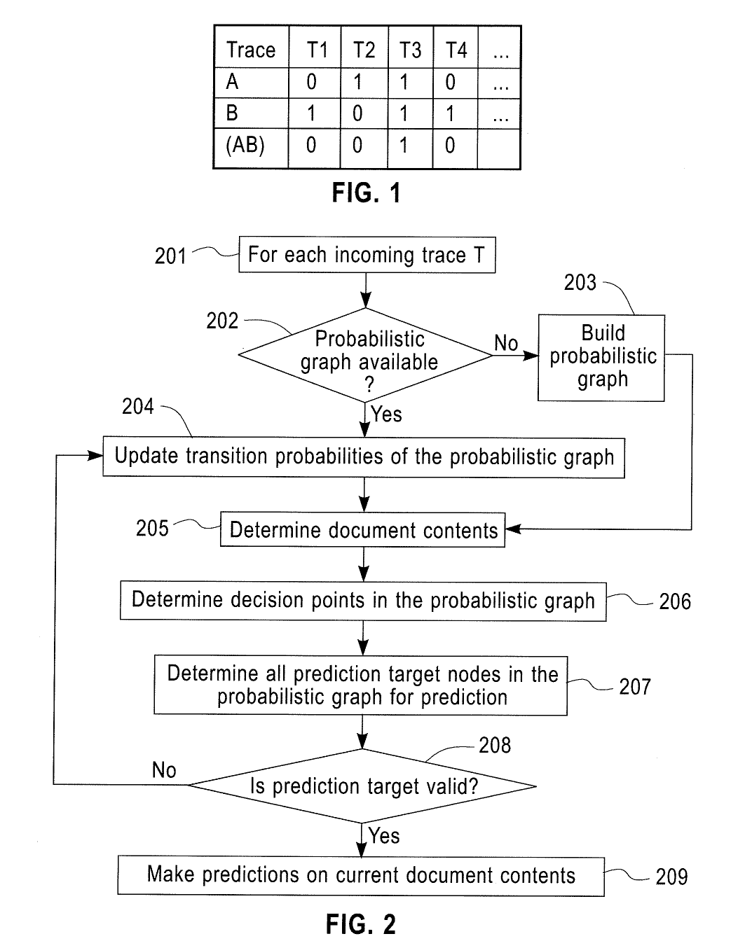

FIG. 1 shows a pairwise Pearson correlation for two ToDos, A and B that occur in a case execution. The correlation may be used to predict whether B occurs given A occurred or vice versa using Pearson correlation coefficients. Boolean logic may be imposed to design new variables that combine two or more activities.

More particularly, given an execution time series S=(s₁,s₂, . . . ,sₖ), its mean and variance may be defined as follows:

$$E ( S ) = \frac{1}{k} {\sum }_{i = 1}^{i \leq k} {S}_{i}$$

$$var ( S ) = \frac{1}{k} {\sum }_{i = 1}^{i \leq k} {S}_{i}^{2} - [ \frac{1}{k} {\sum }_{i = 1}^{i \leq k} {S}_{i} ]$$

Given two load time series, S₁ and S₂, their covariance and correlation coefficient are defined as:

$$cov ( {S}_{1} , {S}_{2} ) = \frac{1}{k} {\sum }_{i = 1}^{i \leq k} {S}_{1 i} {S}_{2 i} - ( \frac{1}{k} {\sum }_{i = 1}^{i \leq k} {S}_{1 i} ) ( \frac{1}{k} {\sum }_{i = 1}^{i \leq k} {S}_{2 i} )$$

$$ρ = \frac{COV ( {S}_{1} , {S}_{2} )}{\sqrt{var {S}_{1}} \cdot \sqrt{var {S}_{2}}}$$

For a given interval of length k, the mean and variance of each time series is determined. Thereafter, a covariance between two time series, S₁ and S₂, is determined.

Once a correlation has been determined it may be used to predict the outcome of an activity instance based on the contents of the documents it has access to. The probabilistic graph is used automatically determine the decision points (e.g., activities where decisions are made) in a case management scenario, and use the decision tree method to learn the circumstances under which document contents accessed by a particular decision point would lead to different outcomes.

FIG. 2 is a flow diagram for a method for an end-to-end prediction. For each trace 201, given a probabilistic graph, document content is determined 205, decision points in the probabilistic graph are determined 206, prediction target nodes in the probabilistic graph are determined 207, and if a valid prediction target is determined 208, predictions are made on current document contents 209. A valid node has an edge connected to the decision node in the probabilistic graph. If a probabilistic graph is determined to be available 202, the method updates transition probabilities 204 prior to determining the document data 205. Note that in a case where the probabilistic graph is available, blocks 205-207 may be updates to previously determined data/decision points/prediction targets. If a probabilistic graph is determined not to be available 202, the method builds a probabilistic graph 203 prior to determining the document data 205.

More specifically, the end-to-end prediction may be described in psuedocode as follows: 1. For each incoming trace T
2. Run probabilistic_mining_ALG to update transition probabilities of the current graph G(V, E).
3. Update matrix M with activity and document content for row T.
4. Update list of decision points D in G (that have document content access).
5. Update list of all prediction target nodes K in G for prediction.
6. For each decision node, dᵢ, in D.
7. For each prediction target node, kᵢ, in K
8. If kᵢ is a valid prediction target for dᵢ
9. If kᵢ!=d, and dᵢ is an ancestor of kᵢ
10. Find all numerical values (nᵢ) in all documents accessed by dᵢ in M and find all occurrences of activity nodes dᵢ and kᵢ, and create correlation matrix mᵢ for (dᵢ, kᵢ, nᵢ)
11. Set T.tree-breadth=100, breadth_LIMIT=10
12. While T.tree-breadth>TREE_BREADTH_LIMIT
13. Run J48 on M(dᵢ,kᵢ) to obtain T 213
14. T.Tree-leaf width
15. Traversing binary tree T, and make predictions on current document contents d^{c}.
16. For non-decision nodes (V-D), compute covariance between each pair of nodes (v₁,v₂).

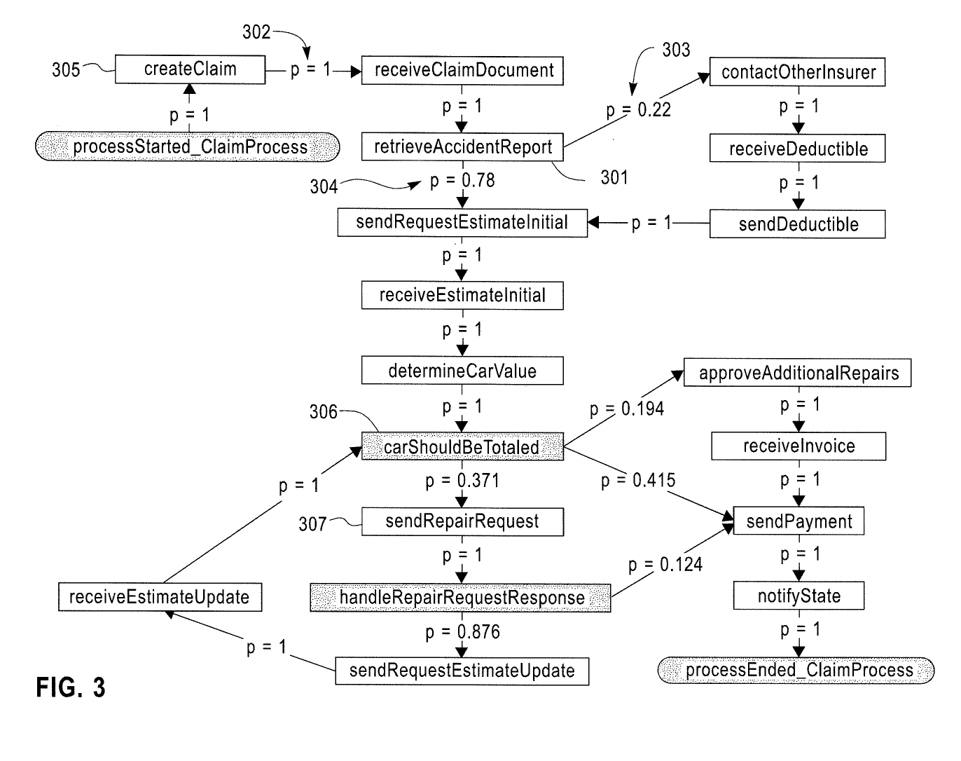

Referring to block 203, ACO-based methods have been applied to stochastic time varying problems such as routing in telecommunications networks and distributed operator placement for stream processing systems. These methods are well known for their dynamic, incremental and adaptive qualities. Since case executions are not typically driven by a formal process model, and are non-deterministic, driven by humans, and document content, ACO is used to obtain a probabilistic graph that can provide decision points rather than continually mining a formal process model from case oriented process data to achieve the same goal. In view of the foregoing, the present disclosure is not limited to ACO methods, and includes any other method that yields a probabilistic graph having decision points. A decision point is a block in the probabilistic graph having at least two prediction target nodes, e.g., retrieveAccidentReport in FIG. 3, node 301. Note that the probability of any node in the probabilistic graph with only one target node is equal to 1 (e.g., 302), or is certain to occur, while the probabilities of an activity occurring given a decision point are less than 1 (e.g., 303) in the case of multiple target nodes, and the sum of the probabilities corresponding to all target nodes occurring given a decision point is equal 1 (e.g., 303-304).

It should be appreciated that a prediction target or outcome can be an immediate next node in an execution or another, subsequent, node in the execution including a final outcome of the process.

By periodically decaying probabilities, ACO methods ensure that transitions that did not execute recently in the case scenario have a lower probability in the mined probabilistic graph. Furthermore, at block 204 ACO may be used to update an existing probabilistic model, whereas typical process mining methods do not have a way to dynamically and automatically update an existing process model. For example, some process mining methods require explicit change logs to compute changes to a process model.

Each process definition may be modeled using a directed graph, G(V, E), in which the nodes, V, of the graph are activities in a semi-structured case oriented process and edges, E, indicate control flow dependencies between activities. Each vertex in the graph has a set of neighbors, N(V). Vertex v maintains a transition vector that maps each neighbor vertex k into a probability φᵥ^{k}, of choosing□neighbor k as the next hop to visit from v. Since these are probabilities, Σ_{kεN(v)}φᵥ^{k}=1. φᵥ represents the transition vector at vertex v, which contains the transition probabilities from v to all of v's neighbors in N(v). Pheromone update rules from ACO may be used to update the transition vector probabilities. Each time an edge eᵥ,k is detected in a process trace file φᵥ^{k} is updated. φᵥ^{k} represents the probability of arriving at k as the next hop from vertex v. The transition vector at vertex v is updated by incrementing the probability associated with neighbor node k, and decreasing (by normalization) the probabilities φᵥ^{q} associated with other neighbor nodes q, such that q≠k. The update procedure modifies the probabilities of the various paths using a reinforcement signal r, where rε[0,1]. The transition vector value at time t is increased by the reinforcement value at time t+1 as shown in the exemplary equation that follows:

Φᵥ^{k}(t+1)=Φᵥ^{k}(t)+r·(1−Φᵥ^{k}(t)) (1)

Thus, the probability is increased by a value proportional to the reinforcement received, and to the previous value of the node probability. Given the same reinforcement, smaller probability values are increased proportionally more than larger probability values. The probability φᵥ^{q} is decayed for all neighbor nodes where qεN(v), and q≠v. The decay function helps to eliminate edges, and consequently nodes, in G that cease to be present in the process execution traces and are thus indicative of changes in the process model. These |N(v)|−1 nodes receive a negative reinforcement by normalization. Normalization may be used to ensure that the sum of probabilities for a given pheromone vector is 1.

Φᵥ^{q}(t+1)=Φᵥ^{q}(t)·(1−r),q≠k (2)

While a probabilistic graph representation of the underlying process is useful, it also has some limitations. For example, a probabilistic graph may generate a case execution sequence that is not reflected in any of the traces parsed to generate the graph. Further, a probabilistic graph does not retain information about parallelism detected in execution traces. Any probabilistic graph mined from process data assumes that all points where control flow splits, referred to as decision points, in the data are exclusive ORs, because of the resulting graph does not retain information about parallelism. Modeling only exclusive OR type decisions in an exemplary auto insurance scenario described herein (see FIG. 3) suffices for the purposes of describing the circumstances under which control flow is guided by document contents. Heuristics may be used to address these limitations.

Turning now to blocks 205-206 of FIG. 2 and methods of learning decision trees for choices obtained by ACO, a decision point, e.g., block 301, corresponds to a place in an execution sequence where the process splits into alternative branches. Having automatically identified decision points through ACO, the impact of the document content on a decision and whether the impact can help to predict different types of outcomes in the case are considered.

Every decision point is converted into a classification problem. Case instances in the log may be used as training examples. The attributes to be analyzed are case attributes contained in the log such as numerical values in documents accessible at an activity, e.g., car value, damage estimate in the auto insurance scenario. A training example for a decision point, d, contains data from n traces, where n in the exemplary case is on the order of thousands of traces. For each trace, a training example for decision point d contains the attribute values available at the decision point, as well as the outcome of the decision point.

The automobile insurance claims scenario shown in FIG. 3 shows activities, e.g., 305, taken by a customer-service representative (CSR), a claim-handler (CH), an adjustor (ADJ), an automobilerepair shop (ARS), and the police department (PD). The roles of the CSR and PD are restricted to a single activity each. Any process may be presented as a conceptual diagram of how cases may be handled by their organization. While the exemplary embodiment is described in connection with the conceptual type flow diagram of FIG. 3, a formal process model may be used.

To simulate a realistic semi-structured case oriented process, the following stochastic variations have been introduced in the simulation:

1. Document content driven decision making. Alternate paths, such as “sendRepairRequest” or “approveAdditionalRepairs”, are taken depending on the values of one or more document contents, such as the “determineCarValue,” “receiveEstimateInitial,” etc.

2. Human decision making. Actors in the simulator have properties modeled as probabilities, such as the Claim Handlers probability of overestimating the car value.

3. Invalid deviations. Activity outcomes may deviate from expected behavior. For example the notify state activity is typically executed when the dollar amount in the payment document is greater than a threshold (e.g., in accordance with typical state laws). However, due to deviations that introduced in the simulator, the state may sometimes not be notified, even when the payment document dollar amount exceeds the threshold.

FIG. 3 shows the result of applying ACO on 2000 traces of the simulator for one of many sets of parameter-values. The experiment compares the results of applying ACO to three sets of 2000 traces where each set involves the simulator being configured with different settings. The three resulting ACO graphs have different sets of mined activities, and while the sets overlapped, they are not identical. This validates the simulator model for a non-deterministic case oriented process. It should be noted that the probabilistic graph in FIG. 3 may include paths not reachable in a given process, and in general is not guaranteed to exclude all unreachable paths. This is a limitation of the exemplary scenario and is not intended to limit the scope of the present disclosure.

Experimental analysis illustrates the effectiveness of learning decision trees for a decision point provided by the probabilistic graph and in particular the effectiveness of the decision tree in predicting different outcomes based on document contents.

Predicting immediate one hop outcomes. The ACO-based probabilistic graph in FIG. 3 indicates that the case has three main decision points. The carShouldBeTotaled decision point because it has three immediate potential outcomes. The document contents accessed by carShouldBeTotaled are examined to predict under what circumstances (i.e. document content values) a case leads to sendRepairRequest and under what circumstances (i.e. document content values) a case leads to approveAdditionalRepairs. In order to formulate the decision problem the values of the document content variables (six attributes in this scenario) that are accessible to carShouldBeTotaled are examined.

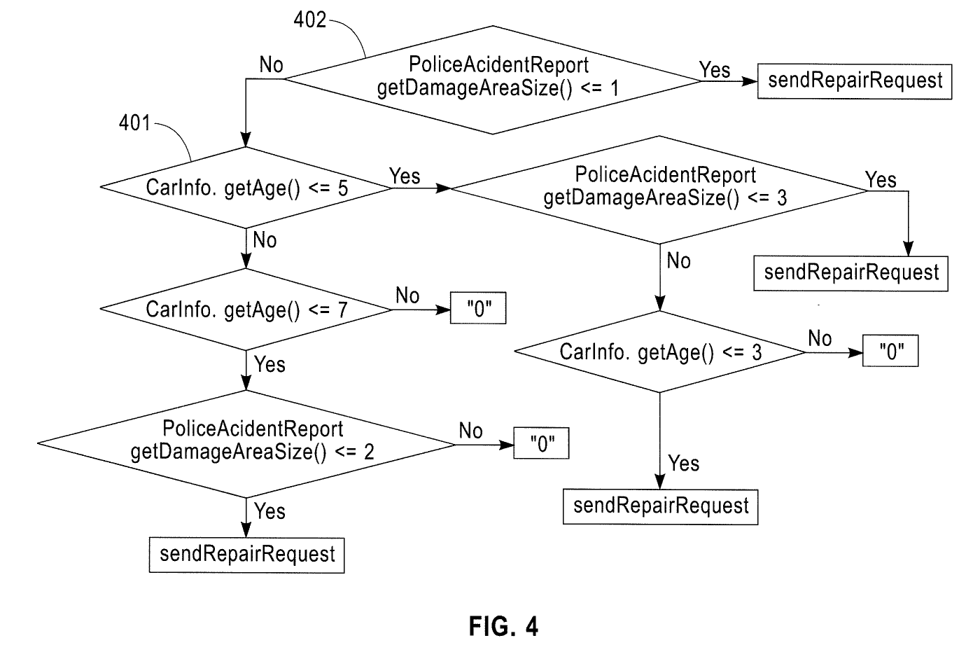

FIG. 4 is a binary decision tree learned to predict whether sendRepairRequest would execute given the document contents accessible at carShouldBeTotaled (306 in FIG. 3). The decision tree of FIG. 4 (obtained with 80% prediction accuracy) was learned by a C4.5 decision tree learning for predicting sendRepairRequest (307 in FIG. 3) where a parameter minNumObj of the Weka library was restricted to 100. minNumObj refers to a minimum number of traces classified by a given leaf node of the decision tree. A larger value of minNumObj corresponds to the aggregation of more cases per leaf node, and thus a simpler decision tree. The determination in the simulator code for sendRepairRequest may be written as “if the total estimated damage is less than the current computed value of the car, go to sendRepairRequest.” Since (A) the current computed value of the car depends on the make/model (and varies a way that would look random) and also on the age of the car (in a way that would work well with a classifier system), and (B) the total-estimated-damage increases with the damage-area-size, the decision tree uses CarInfo.getAge( ) 401 and the PoliceAccidentReport.getDamageAreaSize( ) 402, which are applied multiple time using different variables. The decision tree learned for predicting approveAdditionalRepairs based on the document contents accessed at carShouldBeTotaled is similarly meaningful. A decision tree for sendPayment from carShouldBeTotaled was not calculated because the probabilistic graph indicates that sendPayment always executes after approveAdditionalRepairs and because the decision trees from carShouldBeTotaled has been learned for all other immediate outcomes.

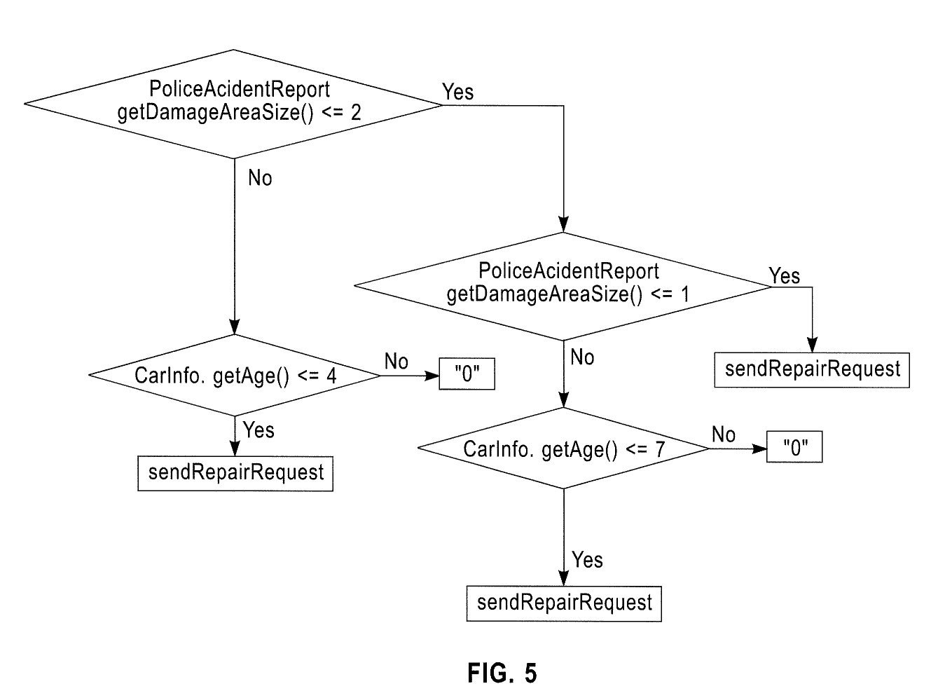

A case worker may find it useful to know whether a case will eventually lead to sendRepairRequest at the point where he or she is still retrieving the accident report at retrieveAccidentReport. In order to answer this question a decision tree may be learned for predicting whether sendRepairRequest would execute based on the document contents accessed at retrieveAccidentReport. The corresponding decision tree has an 80% accuracy and is shown in FIG. 5. This result is surprising because the tree and prediction accuracy indicates that a meaningful prediction can be made about the likelihood of a repair request being sent at the point where a case has reached the retrieveAccidentReport stage in its execution, even though all the data necessary to make the decision about whether the repair request should be sent is not known at the stage of retrieveAccidentReport. In particular, the variable, CarInfo.getValue( ) which plays a role in the decision for sendRepairRequest is not initialized at retrieveAccidentReport. Given these results, the system can make a recommendation to a case worker to begin gathering documents to send the repair request if the current document contents meet the decision trees prediction of sendRepairRequest. It is important to note that 80% accuracy is applicable to the specific test runs that we ran. For 80% of the test runs, the prediction is correct.

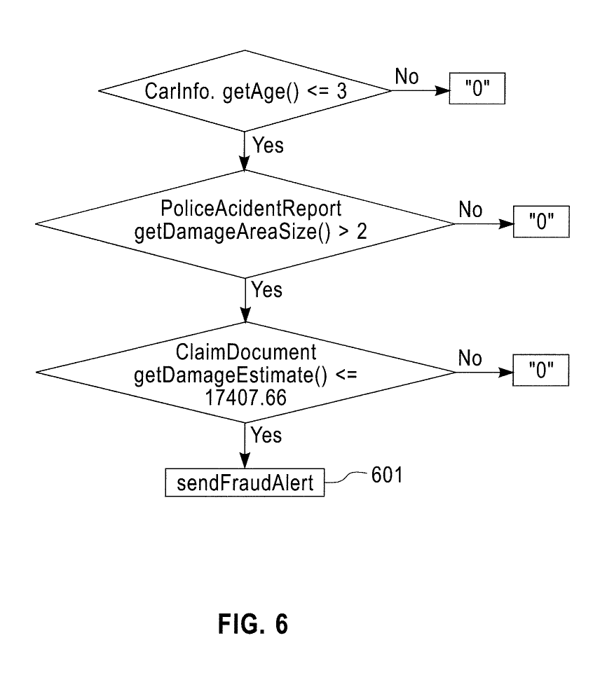

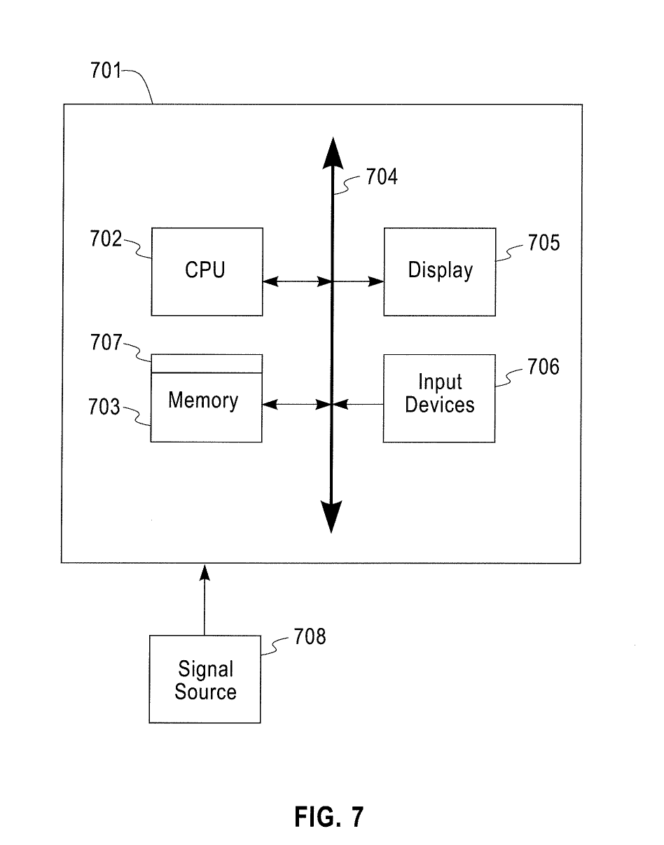

It may be valuable to predict the final outcome of a case when a case worker is involved in an activity somewhere in the middle of the cases execution. In Order to explore this question we first introduced a second final outcome in the simulator called sendFraudAlert that executes after handleRepairRequestResponse and indicates that the auto shop detected that a false repair claim was sent, and cancels any work on the case. Using the simulator to obtain a decision tree for predicting whether sendFraudAlert would execute based on the document contents accessed at carShouldBeTotaled. FIG. 6 is a binary decision tree learned to predict whether sendFraudAlert 601 would execute given the document contents accessible at carShouldBeTotaled showing the corresponding decision tree which predicts this situation with 96% accuracy. This could be extremely useful for a case worker because he or she could cancel the case or send the case to an auditor rather than having to process a fraudulent case unnecessarily. Our system could make such a recommendation to the case worker by evaluating the document contents against the decision tree.

Recall that increasing the value of the Weka library parameter, minNumObj, leads to a simpler decision tree. On average over all experiments, the value of minNumObj was adjusted to 100 from an initial value of 2, the prediction accuracy of Wekas C4.5 method decreased by at most 2%.

It is to be understood that embodiments of the present disclosure may be implemented in various forms of hardware, software, firmware, special purpose processors, or a combination thereof. In one embodiment, a method for predictive analytics for case-oriented semi-structured processes may be implemented in software as an application program tangibly embodied on a computer readable medium. As such the application program is embodied on a non-transitory tangible media. The application program may be uploaded to, and executed by, a processor comprising any suitable architecture.

Referring to FIG. 7, according to an embodiment of the present disclosure, a computer system 701 for implementing predictive analytics for case-oriented semi-structured processes can comprise, inter alia, a central processing unit (CPU) 702, a memory 703 and an input/output (I/O) interface 704. The computer system 701 is generally coupled through the I/O interface 704 to a display 705 and various input devices 706 such as a mouse and keyboard. The support circuits can include circuits such as cache, power supplies, clock circuits, and a communications bus. The memory 703 can include random access memory (RAM), read only memory (ROM), disk drive, tape drive, etc., or a combination thereof. The present invention can be implemented as a routine 707 that is stored in memory 703 and executed by the CPU 702 to process the signal from the signal source 708. As such, the computer system 701 is a general-purpose computer system that becomes a specific purpose computer system when executing the routine 707 of the present invention.

The computer platform 701 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Having described embodiments for predictive analytics for case-oriented semi-structured processes, it is noted that modifications and variations can be made by persons skilled in the art in light of the above teachings. It is therefore to be understood that changes may be made in exemplary embodiments of disclosure, which are within the scope and spirit of the invention as defined by the appended claims. Having thus described the invention with the details and particularity required by the patent laws, what is claimed and desired protected by Letters Patent is set forth in the appended claims.

What is claimed is:

1. A computer readable storage medium embodying instructions executed by a plurality of processors to perform predictive analytics for a process, the method comprising:
receiving at least one trace of the process;
building a probabilistic graph modeling the at least one trace;
determining content at each node of the probabilistic graph, wherein a node represents an activity of the process and at least one node is a decision node;
modeling each decision node as a respective decision tree; and
predicting, for an execution of the process, a path in the probabilistic graph from any decision node to a prediction target node of a plurality of prediction target nodes given the content.

2. The computer readable storage medium of claim 1, wherein the path corresponds to a most likely prediction target node given the content.

3. The computer readable storage medium of claim 1, wherein the trace is correlated case history data of the process.

4. The computer readable storage medium of claim 1, the method further comprising updating transition probabilities prior to determining the content based on reinforcement or decay at each node of the probabilistic graph given a new trace of the process.

5. The computer readable storage medium of claim 1, the method further comprising determining whether each of the prediction target nodes is valid given the decision node, wherein a valid node has an edge connected to the decision node in the probabilistic graph.

6. The computer readable storage medium of claim 1, wherein predicting the path comprises determining correlation coefficients between the decision node and the prediction target nodes and predicting a one hop outcome of the decision node.

7. The computer readable storage medium of claim 1, wherein predicting the path comprises determining correlation coefficients between the decision node and the prediction target nodes and predicting a multi-hop outcome of the decision node.

8. The computer readable storage medium of claim 1, the method further comprising determining a covariance between a pair of non-decision nodes.

9. The computer readable storage medium of claim 1, wherein the trace is a partial trace.

10. The computer readable storage medium of claim 1, wherein the execution of the process is incomplete.

11. A computer readable storage medium embodying instructions executed by a plurality of processors to perform predictive analytics for a process, the method comprising:
receiving a probabilistic graph modeling the at least one trace of the process, wherein a node of the probabilistic graph represents an activity of the process and at least one node is a decision node;
determining content at each node of the probabilistic graph;
modeling each decision node as a respective decision tree; and
predicting, for an execution of the process, whether two nodes of the probabilistic graph coincide given the content, wherein the content is used to determine correlation coefficients between the two nodes.

12. The computer readable storage medium of claim 11, wherein the prediction is for two different groups of nodes of the probabilistic graph, wherein the content is used to determine correlation coefficients between the two different groups of nodes.

13. The computer readable storage medium of claim 1, wherein the trace is correlated case history data of the process.

14. The computer readable storage medium of claim 11, the method further comprising updating transition probabilities prior to determining the content based on reinforcement or decay at each node of the probabilistic graph given a new trace of the process.

15. The computer readable storage medium of claim 1, wherein the execution of the process is incomplete.
